(19) United States
(12) Patent Application Publication
(10) Pub. No.: US 2009/0021397 A1
(43) Pub. Date: Jan. 22, 2009

(54) Method and System for Preventing the Intrusion of a Displaceable Object into a Section of a Traffic Route

(76) Inventors: Heinz Wipf, Zurich (CH); Alfred Seiterle, Pfaffhausen (CH)

Correspondence Address: LERNER GREENBERG STEMER LLP, P O BOX 2480, HOLLYWOOD, FL, 33022-2480, US

(21) Appl. No.: 12/279,659

(22) PCT Filed: Feb. 5, 2007
(86) PCT No.: PCT/EP2007/000971

§ 371 Date: Oct. 8, 2008

(30) Foreign Application Priority Data
Feb. 18, 2006 (DE) 10 2006 007 644.3

(51) Int. Cl. G08B 21/00

(52) U.S. Cl. 340/945

(57) ABSTRACT

A system and a method for warning a person, steering a displaceable object, of an intrusion of the object into a section of a traffic route that is at least temporarily protected. The system includes an activatable device for determining the location of the displaceable object in relation to a threshold; a device for comparing the distance of the displaceable object from the threshold with a threshold value, to determine whether the threshold has been violated; and a transmitter and a receiver situated in the displaceable object. If the threshold is violated and simultaneously activated, the transmitter emits warning signals that are tuned to the receiver. The receiver of the displaceable object supports a plurality of predefined radio channels and the transmitter sends the warning signals on all the channels. The system further has a device situated in the object for acoustic and/or optical emission of the warning signals.

The present invention relates to a method and a system for warning the driver of a displaceable object about an intrusion of the displaceable object into a section of a traffic route which is, at least temporarily, protected.

Traffic routes, such as roads, rail tracks, shipping lanes and airport areas, for displaceable objects such as automobiles, trucks, trains, ships and aircraft, are generally not without intersections. For the purpose of controlling the traffic on these traffic routes, visual and/or audible signals are directed to the driver(s) of the displaceable object who, on the basis of his/her experience and/or training, interprets them as instructions to halt or to proceed. So for example, devices for generating optical signals, such as traffic lights, warning lights and diagonal crosses, are generally set up in the immediate vicinity of the sections which are temporarily protected, such as for example crossroads, double crossover points/switches, take-off and landing runway crossings, and enable a driver who is driving in an appropriate fashion to stop in good time before the temporarily protected section when a halt indication is displayed.

In spite of this it repeatedly happens, mainly because of human error, that an object intrudes into such a temporarily protected section, with danger to people and things, even though all the signaling devices have sent out the halt indication. For the purpose of averting accidents of this type, modern train safety systems, for example, have so-called enforced braking routines which initiate the enforced braking of a train if the train driver has not acted on a halt indication, for example drives past a track signal showing a red signal light.

However, there are absolutely no similar routines for road traffic, shipping or air traffic. For air travel, the flight controller can, if he has visual contact with the aircraft or ground vehicle or has radar for determining its position, still intervene, for example, if the aircraft or ground vehicle drives without permission into a take-off or landing runway. Appropriate detectors at the halt lines can indeed report the intrusion to the control tower. However, if there is no direct radio link to the pilot at this point in time, for example because the flight controller in the control tower and the pilot have just selected different channels, then here again it is impossible to give a warning. Nevertheless, all these displaceable objects often have a common characteristic in that they have one or more radio-electrical receiving devices (such as radio broadcast, operating radio).

The objective underlying the present invention is therefore to specify a method and a system by which it is better possible, by a direct warning to the driver of the displaceable object, to avoid the intrusion of a displaceable object into a section of a traffic route which is temporarily protected.

In accordance with the invention, this objective is achieved in respect of the method by a method for warning a driver of a displaceable object against the intrusion of the displaceable object into a section of a traffic route which is at least temporarily protected by which:
a) a previously defined boundary of the temporarily protected section is activated;
b) the current location of the displaceable object is determined relative to this boundary;
c) the distance of the displaceable object from the boundary is compared against a previously defined limit value in such a way that it is possible to determine whether the activated boundary has been infringed by the displaceable object; and
d) in the event of an infringement of the boundary at the same time as the boundary is activated, a transmission device is activated which transmits warning signals tuned to a receiving device on the displaceable object, for presentation to the driver at the object end, where
e) the receiving device of the displaceable object supports a plurality of predefined radio channels and the transmission device emits its warning signals on all these predefined radio channels.

In accordance with the invention, this objective is achieved in respect of the system by a system for warning the driver of a displaceable object against the intrusion of the displaceable object into a section of a traffic route which is at least temporarily protected, including:
a) a previously defined boundary of the temporarily protected section, which can be activated;
b) facilities for determining the current location of the displaceable object relative to this boundary;
c) facilities for comparing the distance of the displaceable object from the boundary against a previously defined limit value for the purpose of determining whether the activated boundary has been infringed by the displaceable object;
d) an activatable transmission device and a receiving device arranged on the displaceable object, whereby if the activated boundary is infringed at the same time as the boundary is activated the transmission device can be activated in order to emit warning signals tuned to the receiving device of the displaceable object, and whereby the receiving device of the displaceable object supports a plurality of predefined radio channels and the transmission device emits its warning signals on all these predefined radio channels; and
e) facilities are provided at the object end for emitting the warning signals audibly and/or visibly for the driver.

It is possible in this way to detect the entry of the displaceable object into the temporarily protected section and, from the simultaneous occurrence of an infringement of the limit value by the entry and the activation of the boundary, to transmit the warning signals tuned to the driver's receiving facilities. Meaningful logic for this situation can, for example, represent the two events by an AND combination. The influence on the driver then acts locally, with no detour via a central control system which might possibly be too time consuming. To clarify this solution, it is further remarked that the facilities for determining the current location of the distance of the displaceable object can even be merely a single detector assigned to the boundary, which gives a signal when the object is located at or on the boundary. In this case, therefore, the current location of the displaceable object is only subject to binary monitoring, i.e. either “object at or on the boundary” or “no object at or on the boundary”. The method and the system are especially safe because the displaceable object's receiving device supports a plurality of predefined radio channels, and the transmission device emits its warning signals on all these predefined radio channels. In this way, the crew of an aircraft or ground vehicle cockpit can in every case be reached with these warning signals, because at least one of these predefined radio channels will by default always be ready-to-receive. In this situation, due to the short warning time which is available it is particularly sensible if the transmission device preferably emits the warning signals on these predefined radio channels simultaneously.

Typically, the previously defined boundary can be at least a signal light, which lights up if it is activated to signal a halt instruction and in doing so consumes electrical power, the current for which is detected to determine the activated state. Thus, the above-mentioned AND combination is satisfied if the current flow which lights up the signal light is detected and the distance of the displaceable object from the boundary goes below the limit value. In respect of the example cited above, with only one detector, the limit value is regarded as being undershot if the detector is activated.

It is expedient if the current position of the displaceable object is detected by at least one sensor arranged on the displaceable object's traffic route. Sensors which are suitable for this purpose are, for example, inductive loops, capacitive sensors, radar sensors, pressure sensors, multilateration and the like.

For the purpose of increasing the accuracy of reporting of the current location of the displaceable object, and its approach to the boundary, the direction of movement of the displaceable object can be distinguished by means of at least two sensors.

Alternatively or in addition to the sensors cited above for determining the current location of the displaceable object, the current location of the displaceable object can also be determined using navigation facilities arranged on the displaceable object. Especially suitable for this way of distinguishing the current location are satellite-based systems, such as GPS or Galileo (under construction), for which the modules arranged on the displaceable object report the current position, for example to a management system. From there it is then possible to abstract the data required for the limit value comparison.

A preferred method for the simultaneous emission of the warning signals can provide that the number of predefined radio channels is formed as the addition of time-harmonic functions, each with an integral multiple of a spacing between two adjacent radio channels and, by means of a modulator, to modulate the content element of the warning signal onto all the radio channels thus formed.

For the purpose of avoiding the disturbance of other traffic participants by warning signals which are not currently intended for them, the transmission device can be arranged in the immediate vicinity of the boundary, and its transmission power so adjusted that the receiving device on the displaceable object located in the region of the boundary, which has indeed caused the warning signals to be emitted, is the only one still able to receive the warning signals.

In order that existing systems for securing travel routes, such as light beams or systems of signaling lights, can be modified to the new method/system in accordance with the invention without major conversion, it is particularly expedient if the transmission device is arranged on a lighting facility associated with the boundary, and is supplied with electric power via its supply voltage. Examples of lighting facilities associated with the boundary are the individual lighting facilities for signaling and identifying the runways, which are components of the taxiway and apron lighting and of the signage of an airport respectively.

Furthermore, for the implementation of this investment-saving concept, provision can be made for activating the transmission device to emit the warning signals by a signal modulated onto the supply voltage. As an addition or an alternative, the transmission device can also transmit back data, by signals modulated onto the supply voltage or via signaling cables, such as in particular data for status reporting.

Particularly in the case of international cross-border traffic, there is an increased need, and one which indeed generally exists of necessity, for regulated signals and/or announcements. Preferably, the warning signals will therefore include a predefined warning text. To give more flexible options for adaptation, the predefined warning text can as an enhancement be selected for individual situations from a number of predefined warning texts.

Advantageous embodiments of the invention are specified in further claims.

Exemplary embodiments of the present invention are explained in more detail by reference to a drawing. This shows:

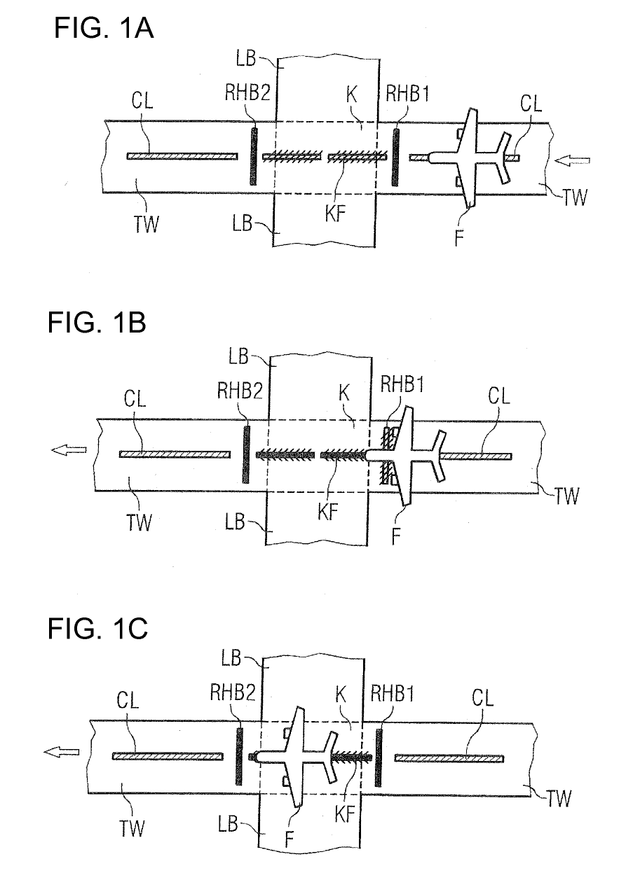

FIG. 1 a schematic representation in three parts a) to c) showing the passage of an aircraft or ground vehicle over a runway crossing;

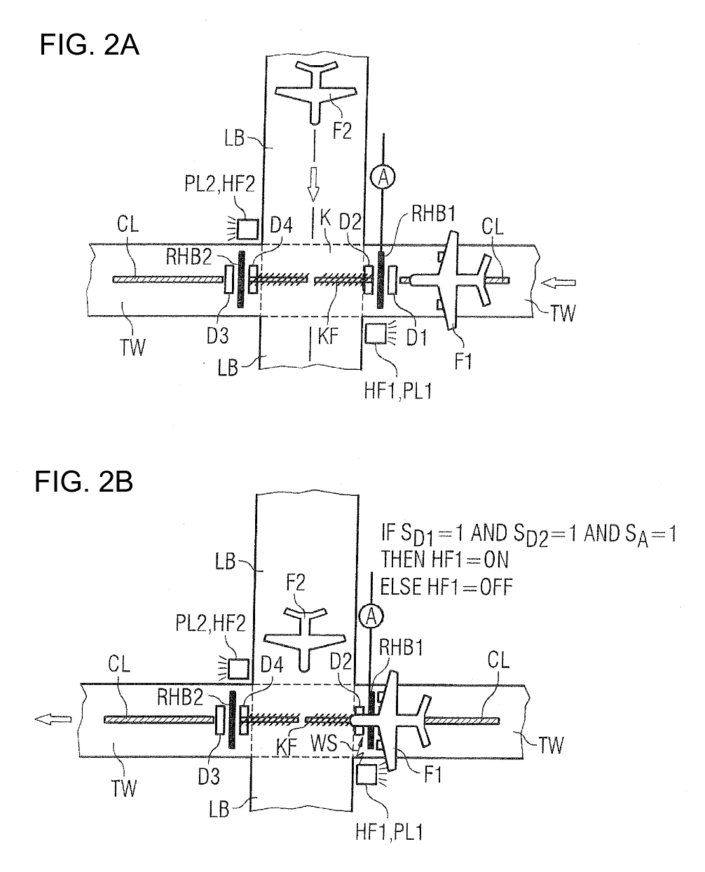

FIG. 2 a schematic representation, with parts a) and b), of a system for warning of an unauthorized intrusion by the aircraft or ground vehicle into the runway crossing shown in FIG. 1;

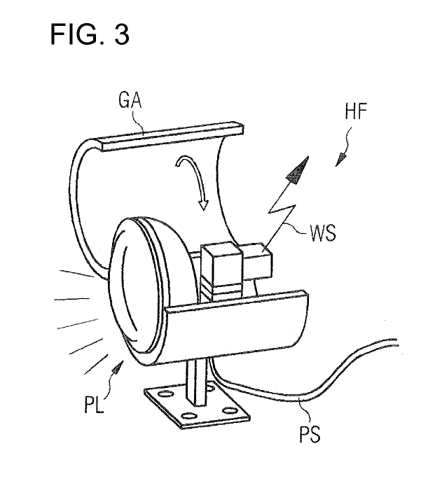

FIG. 3 a schematic representation of a runway signaling light with integral transmission device;

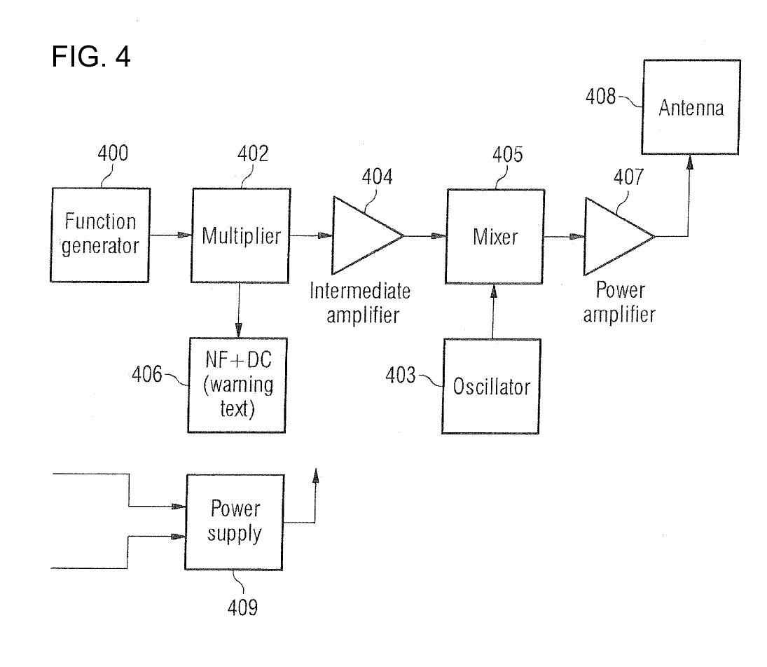

FIG. 4 a first schematic of the structure of the transmission device shown in FIG. 3 for AM transmission;

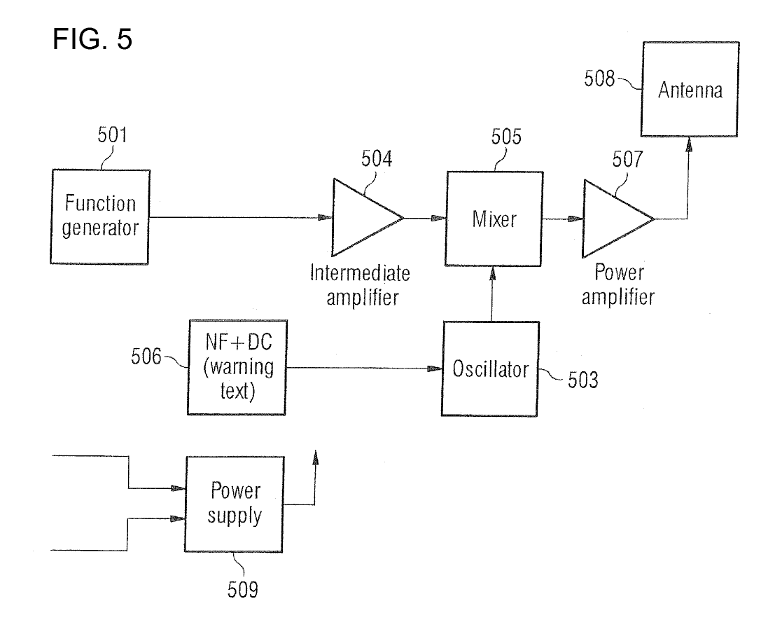

FIG. 5 a second schematic of the structure of the transmission device shown in FIG. 3 for FM transmission; and

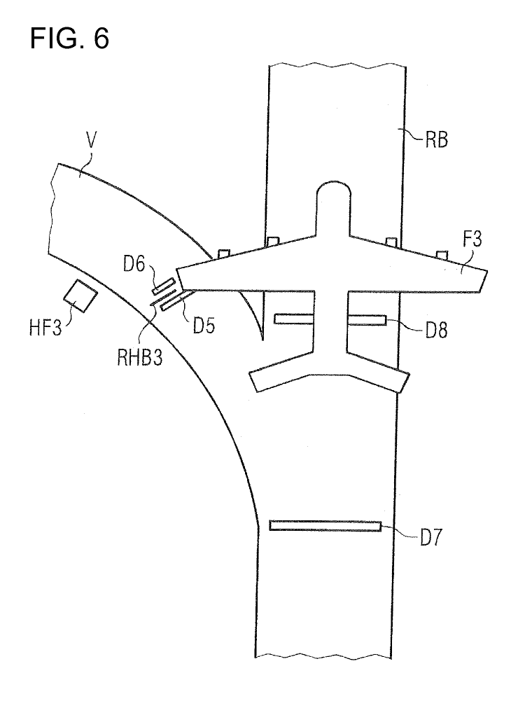

FIG. 6 a schematic representation of a view from above of a presumed boundary infringement situation where a wing is above a stop bar at a runway branch.

FIG. 1 shows in schematic form a section of a taxiway on an airfield. The section drawn shows a section of a landing runway LB and of a taxiway TW, which is currently being used by an aircraft or ground vehicle F. In the central region of the diagram is an intersection K, which in the sense of the present invention is regarded as the temporarily protected stretch of a traffic route, namely the landing runway LB. This is indicated by the dashed edging of the intersection K. In addition to the lighting of the landing runway LB, which is not shown further here, the taxiway TW also has a central line of lights CL and an intersection light KF which can be switched according to the intended direction.

In FIG. 1a), the aircraft or ground vehicle F is standing ready to roll across the intersection K, from right to left in the diagram. Initially two stop bars RHB1 and RHB2 light up to the right and the left of the landing runway LB, because the intersection K is at first still blocked, i.e. it is temporarily protected. The diagonal dashes across the intersection light KF are intended to indicate that the intersection light KF is still switched off at this point in time.

FIG. 1b) now shows the situation where the intersection K can be released, from the point of view of the occupancy of the landing runway LB. To effect this, the stop bar RHB1 goes out (indicated by the diagonal dashes) and the intersection light KF lights up in the intended direction of travel of the aircraft or ground vehicle F (indicated by the arrows on the intersection light KF).

As shown in FIG. 1c), the aircraft or ground vehicle F has now almost crossed over the intersection. The stop bar RHB1 on the right, which has already been passed, lights up again to indicate to any aircraft or ground vehicle which may be following behind that the intersection K is now initially temporarily protected again after the passage of the aircraft or ground vehicle F. The stop bar RHB2 on the left stays lit during the entire operation, because in this exemplary embodiment the aircraft or ground vehicle F is making its way from the right-hand side of the landing runway to the left-hand side, and not vice versa. When the aircraft or ground vehicle F has then also passed the left stop bar RHB2, the intersection light KF will also go out again. There then remains the continuous lighting along the landing runway LB.

FIG. 2, with its parts a) and b), now shows in schematic form the structure of the system in accordance with the invention and the way in which the method in accordance with the invention functions. In the present case, a first aircraft or ground vehicle F1 wishes to move on the taxiway TW, from right to left in the diagrammatic illustration, and in doing so must cross over the landing runway LB, and thus the intersection K. However, a second aircraft or ground vehicle F2 is currently using the landing runway LB (the use of the landing runway LB will generally be reserved for the aircraft or ground vehicle F2 even as it is still on its approach path to the landing runway LB). For this reason, the intersection K which is edged by the dashed line is currently temporarily protected for feeder movements on the taxiways TW. For this reason, the stop bar RHB1 is also lit up, and the intersection light KF is switched off (represented by the diagonal dashes). In the sense of the wording of the patent claims which follow, the stop bar RHB1 thus represents the activatable boundary (which in the present case is also really activated, because it is lit) for the temporarily protected intersection K. Arranged before and after the stop bar RHB1 in the direction of travel of the first aircraft or ground vehicle F1 there are detectors Dl and D2 respectively, for position recognition. These detectors Dl and D2 only emit a signal, S_{D1}=1 or S_{D2}=1 respectively, when an aircraft or ground vehicle, or more accurately a part of an aircraft or ground vehicle, such as for example the nose of the aircraft or ground vehicle, is located directly above them. Connected into the current circuit of the stop bar RHB1 is an ammeter A, to measure the current flowing for the light when the stop bar RHB1 is activated. Alternatively, it would be possible to arrange simply a sensor instead of the ammeter A, in order to detect merely the presence of this lighting current. The ammeter A only emits a signal S_{A}=1 when there is a lighting current flow. Directly beside the taxiway TWY at the intersection K there is a runway signaling light PL. Integrated into this runway signaling light PL. A transmitter HF1 is integrated into this runway signaling light HPL and, if it is activated, repeatedly emits simultaneously on all the radio channels used in the airport compound area a radio message in the form of a warning signal WS “Taxiway TWY, stop bar overrun”, and does so until the condition which activated the transmitter HF is no longer present or the transmitter is actively switched off in some other way.

The criterion for activating this transmitter HF1 is shown both diagrammatically and logically in FIG. 2b). In the exemplary embodiment shown, the first aircraft or ground vehicle F1 has, due to the inattentiveness of the aircraft or ground vehicle driver, driven over the activated stop bar RHB1. As a result, the first aircraft or ground vehicle is now also sensed at the detector D2. Thus the signals S_{D1}, S_{D2} from the two detectors D1 and D2, and the signal S_{A} from the ammeter, are now at a logical “1”. The AND combination of these signals thus also gives a logical “1”, and thereby activates the transmitter HF1, which receives its signal to transmit in the form of a trigger signal modulated on the supply voltage for the runway signaling light PL1. Because the transmitter HF1 is arranged in the immediate vicinity of the first aircraft or ground vehicle F1, which is infringing the protected region, its transmission power can be adjusted so that only a receiving device arranged on the first aircraft or ground vehicle F1 can receive the warning signal WS. Because at least one of the radio channels on the receiving device is always activated, the cockpit crew of the first aircraft or ground vehicle F1 will in every case be reached by this radio message, mentioned above. In this way, the first aircraft or ground vehicle F1 can be stopped without delay by the cockpit crew, whereby the immediate danger of major personal injury or material damage can be averted at the last moment.

In this way it is possible with comparatively limited resources to eliminate a source of danger which, in spite of the high standard of training for cockpit personnel, occurs time and again as a result of human error. If one takes into consideration here the detectors D1 and D2 which frequently already exist, the runway signaling lights PL which are also in place, and the stop bar RHB1 which is obligatory under the rules, all that is required is a logic circuit which forms an AND combination of the signals from the detectors D1, D2 and the signal which indicates the presence of the light current to the stop bar RHB1, and which transmits, via a power supply to the runway signaling lights PL1, an appropriate trigger signal to activate the transmitter HF1 arranged on the runway signaling light PL1.

A runway signaling light equipped in this way is shown in FIG. 3. It is easy to see that the transmitter HF used there is arranged right underneath a hinged housing cover GA in the interior of the runway signaling light PL and also makes shared use of a power supply PS to the runway signaling light PL. The transmitter HF can, in addition, be connected to a service module, not shown further here, having a menu guide which, for example, enables the warning text communicated to be selected from a choice of texts. It is also possible to select the transmission power and if necessary the transmission channels or the type of transmission, e.g. AM or FM, in this way.

The following FIGS. 4 and 5, now show the structure of the transmitter HF in detail, and clarify the generation of the warning signal WS transmitted on the agreed radio channels.

FIG. 4 shows, for amplitude modulation AM, a schematic diagram of the transmission device 400 for emitting the warning signal WS. The function described, consisting of the sum of the time-harmonic signals at the channel spacing for the selected radio band, is generated as an electrical signal in a function generator 401. This signal is modulated in a multiplier 402, this time with a voice signal which corresponds to the stored warning text, and an additive DC voltage 406. (The warning texts themselves can be recorded and/or stored using a microphone. Also, a warning text appropriate to the situation can be selected from a number of warning texts.)

The product is amplified and filtered in an intermediate amplifier 404. An oscillator 403 generates a time-harmonic signal with a frequency in the center of the selected radio band. By means of a mixer 405, this signal is multiplied with the signal originating from the intermediate amplifier 404. This produces the desired amplitude modulated radio signals on all channels in the required radio band. These radio signals are subject to broadband amplification in a regulatable or programmable linear power amplifier 407, and are radiated via a local antenna 408. In this situation it is possible, in a way not shown any further here, to assign to the local antenna 408 an additional control antenna engineered to signal in a backward direction which, when the warning signals WS are emitted, checks the level at which these warning signals WS were emitted. A signal which is entirely missing, or at a level which is too weak, or even too strong, can then result in appropriate checking and/or adjustment actions. The control device 409 evaluates the control signals and, when there is an alarm, supplies the transmission device 400 accordingly with an operating voltage, so that radiation of the programmed voice test on the desired radio channels results automatically.

FIG. 5 shows, for frequency modulation FM, a schematic diagram of a transmission device 500 for emitting the warning signal WS. The function described, consisting of the sum of the time-harmonic signals at the channel spacing is generated as an electrical signal in a function generator 501. These signals are amplified and filtered in an intermediate amplifier 504. An oscillator 503 generates a time-harmonic signal with a frequency in the center of the selected radio band. At the same time, this carrier is frequency- or phase-modulated with a voice signal which corresponds to the stored warning text and which originates from a desired signal generator 506 (here again the warning texts can be recorded and/or stored using a microphone). By means of a mixer 505, this signal is now multiplied together with the signal processed in the intermediate amplifier 504. This produces the desired frequency- or phase-modulated radio signals on all the channels in the required radio band. These radio signals are subject to broadband amplification and band limitation in a regulatable or programmable linear power amplifier 507 and are radiated via a local antenna 508 (here too, there can be a control antenna). A control device 509 evaluates the control signals and, when there is an alarm, supplies the device accordingly with an operating voltage, so that radiation of the programmed voice test results automatically.

These applications generally involve voice radio, and the phase is irrelevant for the human ear, so that the phase of any individual cosine oscillation can be arbitrarily started. As a result the overall form of the complete signal changes favorably in that the crest factor is substantially reduced, which improves the signal-to-noise ratio. For example, a quadratic function of the phase can be used:

U(t)=U₀Σ cos(k*2πft+k²*2πt/N), where:
U(t)—voltage level as a function of time t;
U₀—basic amplitude;
k—kth channel;
f—frequency; and
N—number of channels.

At this point it is noted that it is also possible to use and generate all other common types of continuous and digital modulation. Nor should the exemplary embodiment explained here in any way give rise to the impression that the range of the present invention could be restricted to aviation. Rather, the invention can be applied everywhere where intrusions by displaceable objects into a temporarily protected section of a traffic route are to be prevented by the communication of warnings, in a form appropriate for the capabilities at the receiving end, which can be perceived by the driver of the displaceable object. The driver of the displaceable object is thereby put in a position to avert the unauthorized/unwanted intrusion of the object he/she is driving into the protected section.

Another special case of an advantageous embodiment is shown in FIG. 6. FIG. 6 here shows a schematic representation of a view from above onto a presumed boundary infringement situation, when a wing passes over a stop bar RHB3 at a taxiway branch V. Here, the taxiway branch V starts at the taxiway RB. The stop bar RHB3 here serves to prevent temporarily the intrusion of an aircraft F3 into the areas of the taxiway RB or the take-off/landing runway lying behind the stop bar. When the stop bar RHB3 is illuminated, the associated detectors D5 and D6 are monitored and, if they are triggered, they then initiate the emission of the warning signals WS.

In the present case however, there is no worrying boundary infringement, because only the large port wing of aircraft F3 is passing over the detectors D5 and D6, but the aircraft is actually on the taxiway RB. (Problems of this type can arise as a new possibility at very many airports, with the operation of the new A380 Airbus). In this case however, the detectors D7 and D8 which are assigned to the taxiway RB have signaled, which permits a safe assertion that the aircraft F3 is moving along the taxiway RB and has not turned off into the branch V. Appropriate logic will establish this situation by reference to the signals from the detectors D7 and D8, and thereupon on this occasion prevents the emission of the warning signal WS by a transmitter HF3 assigned to the stop bar RHB3. Hence a way is indicated for excluding the inappropriate emission of the warning signals WS in the case where a wing passes over (as shown in FIG. 6) or triggering by traffic on adjacent traffic routes.

1-24. (canceled)

25. A method for warning a driver of a displaceable object against intrusion by the displaceable object into a section of a traffic route which is at least temporarily protected, which comprises the steps of:
activating a previously defined boundary of a temporarily protected section;
determining a current location of the displaceable object relative to the boundary;
comparing a distance of the displaceable object from the boundary with a previously defined limit value such that it is possible to determine whether the boundary has been infringed by the displaceable object; and
activating a transmission device emitting warning signals tuned to a receiving device on the displaceable object in an event of a boundary infringement at a same time as the boundary is activated, the receiving device being present on an object side for the driver, and the receiving device on the displaceable object supporting a plurality of predefined radio channels and the transmission device emitting the warning signals on all the predefined radio channels.

26. The method according to claim 25, which further comprises:
providing the boundary as at least one light signal which if activated lights up and in doing so consumes electrical power; and
sensing a current of the electrical power for determining an activated state.

27. The method according to claim 25, which further comprises sensing a current position of the displaceable object by at least one sensor disposed on the traffic route of the displaceable object.

28. The method according to claim 27, which further comprises distinguishing a direction of movement of the displaceable object by use of at least two sensors.

29. The method according to claim 25, which further comprises determining a current location of the displaceable object using navigation facilities disposed on the displaceable object.

30. The method according to claim 25, wherein for emitting simultaneously the warning signals, forming a number of the predefined radio channels as an addition of time harmonic functions, cos(2kπft) or sin(2kπft), each with an integral multiple n of a spacing 2πf between two adjacent radio channels, and a content element of the warning signals is modulated onto all the predefined radio channels thus formed by a modulator.

31. The method according to claim 25, which further comprises disposing the transmission device in an immediate vicinity of the boundary, and adjusting a transmission power of the transmission device so that the receiving device on the displaceable object in a region of the boundary is the only receiving device still able to receive the warning signals.

32. The method according to claim 25, which further comprises:
disposing the transmission device on at least one of a lighting facility and a traffic sign associated with the boundary; and
supplying the transmission device with electric power from a power supply of one of the lighting facility and the traffic sign.

33. The method according to claim 32, which further comprises performing one of:
activating the transmission device to emit the warning signals by a signal modulated onto the power supply; and
activating the transmission device to transmit back data, including status reporting data, by signals modulated onto the power supply.

34. The method according to claim 25, which further comprises forming the warning signals to include a predefined warning text.

35. The method according to claim 34, which further comprises selecting the predefined warning text from a number of predefined warning texts.

36. The method according to claim 25, which further comprises suppressing an emission of the warning signals, even if all prerequisites are met for an infringement of the boundary, if it is determined on a basis of signals from detectors other than detectors for the boundary that the displaceable object will not cross the boundary.

37. A system for warning a driver of a displaceable object of an intrusion by the displaceable object into a section of a traffic route which is at least temporarily protected, the system comprising:
an activatable and previously defined boundary of the section being temporarily protected;
a device for determining a current location of the displaceable object relative to said boundary;
a device for comparing a distance of the displaceable object from said boundary against a previously defined limit value for determining whether said boundary upon activation is infringed by the displaceable object;
an activatable transmission device;
a receiving device disposed on the displaceable object, if said boundary is infringed at a same time as said boundary is activated said activatable transmission device is activated to emit warning signals tuned to said receiving device on the displaceable object, and said receiving device on the displaceable object supports a plurality of predefined radio channels and said transmission device emits the warning signals on all of said predefined radio channels; and
a device on an object side for one of an audible emission and a visual emission to a driver of the warning signals.

38. The system according to claim 37, wherein said boundary is at least a signal light which, if activated, lights up and in doing so consumes electric power, a current for said signal light being detected for determining that a state of said signal light is activated.

39. The system according to claim 37, wherein said device for determining the current location includes at least one sensor for sensing the current location of the displaceable object, said sensor disposed in the traffic route for the displaceable object.

40. The system according to claim 39, wherein said sensor is one of at least two sensors for sensing a direction of movement of the displaceable object.

41. The system according to claim 37, wherein said device for determining the current location includes a navigation unit disposed on the displaceable object for determining the current location of the displaceable object.

42. The system according to claim 37, wherein for emitting simultaneously the warning signals, a number of the predefined radio channels is formed as an addition of time harmonic functions, cos(2kπft) or sin(2kπft), each with an integral multiple n of a spacing 2πf between two adjacent radio channels, and a content element of the warning signal is modulated onto all the predefined radio channels thus formed by a modulator.

43. The system according to claim 37, wherein said transmission device is disposed in an immediate vicinity of said boundary and has transmission power adjusted so that said receiving device on the displaceable object in a region of said boundary is the only said receiving device which can still be enabled to receive the warning signals.

44. The system according to claim 37, wherein:
said boundary has a power supply; and
said activatable transmission device is disposed on a signaling facility associated with said boundary, and is supplied with electric power by said power supply.

45. The system according to claim 44, wherein said activatable transmission device can be:
activated to emit the warning signals by a signal modulated onto said power supply; and
activated to transmit back data, by signals modulated onto said power supply.

46. The system according to claim 37, wherein the warning signals include as their content element a predefined warning text.

47. The system according to claim 46, wherein the predefined warning text can be selected from a number of predefined warning texts.

48. The system according to claim 40, further comprising:
further sensors; and
logic devices for suppressing an emission of the warning signals, even if all prerequisites are met for an infringement of said boundary, if it is determined on a basis of signals from said further sensors other than said sensors for said boundary that the displaceable object is not crossing said boundary.

49. The system according to claim 45, wherein the data is status reporting data.
